(19) United States
(12) Patent Application Publication
(10) Pub. No.: US 2025/0227801 A1
(43) Pub. Date: Jul. 10, 2025

(54) IMPROVED POSITIONING CONFIGURATION MANAGEMENT IN RRC INACTIVE STATE

(71) Applicant: QUALCOMM Incorporated, San Diego, CA (US)

(72) Inventors: Srinivas YERRAMALLI, San Diego, CA (US); Alexandros MANOLAKOS, Athens (GR); Mukesh KUMAR, Hyderabad (IN)

(21) Appl. No.: 18/853,367

(22) PCT Filed: May 11, 2023
(86) PCT No.: PCT/US2023/021957

§ 371 Date: Oct. 1, 2024

(30) Foreign Application Priority Data
Jun. 10, 2022 (GR) 20220100483

(51) Int. Cl. H04W 76/27; H04L 5/00; H04W 24/10; H04W 64/00; H04W 74/0838

(52) U.S. Cl. CPC H04W 76/27; H04L 5/0051; H04W 24/10; H04W 64/00; H04W 74/0838

(57) ABSTRACT

Aspects presented herein may enhance positioning configuration management for a UE and/or a positioning entity while the UE is under an RRC inactive state. In one aspect, a UE performs a set of measurements associated with a plurality of DL signals from a first network entity, where the set of measurements is performed during an RRC inactive state of the UE. The UE transmits, based on the set of measurements for the plurality of DL signals, a request for an updated configuration for a set of SRS positioning resources to the first network entity. The UE receives an indication of the updated configuration for the set of SRS positioning resources based on the request.

### CROSS-REFERENCE TO RELATED APPLICATION

This application claims the benefit of Greek application No. 20220100483, entitled “IMPROVED POSITIONING CONFIGURATION MANAGEMENT IN RRC INACTIVE STATE” and filed on Jun. 10, 2022, which is expressly incorporated by reference herein in its entirety.

### TECHNICAL FIELD

The present disclosure relates generally to communication systems, and more particularly, to communication systems involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus performs a set of measurements associated with a plurality of downlink (DL) signals from a first network entity, where the set of measurements is performed during a radio resource control (RRC) inactive state of the UE. The apparatus transmits, based on the set of measurements for the plurality of DL signals, a request for an updated configuration for a set of sounding reference signal (SRS) positioning resources to the first network entity. The apparatus receives an indication of the updated configuration for the set of SRS positioning resources based on the request.

In an aspect of the disclosure, a method, a computer-readable medium, and an apparatus are provided. The apparatus receives a request for an updated configuration for a set of SRS positioning resources from a user equipment (UE), where the request for the updated configuration for the set of SRS positioning resources is based on a set of measurements associated with a plurality of DL signals. The apparatus transmits an indication of at least one of: the updated configuration for the set of SRS positioning resources or a configuration for a contention-free random access (CFRA) procedure at a second network entity.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a communication flow illustrating an example multi-round trip time (multi-RTT) positioning procedure in accordance with various aspects of the present disclosure.

FIG. 6 is a diagram illustrating an example of different radio resource control (RRC) states in accordance with various aspects of the present disclosure.

FIG. 7 is a communication flow illustrating an example of a UE updating positioning configuration in an RRC inactive state in accordance with various aspects of the present disclosure.

FIG. 8 is a communication flow illustrating an example of a UE updating positioning configuration in an RRC inactive state after switching to a new base station in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

Aspects presented herein may improve the latency and efficiency of UE positioning. Aspects presented herein may enhance positioning configuration management for a UE and/or a positioning entity (e.g., a base station, a location server, etc.) while the UE is under an RRC inactive state. For example, aspects presented herein may enable a UE to request a positioning update during an RRC inactive state, such as requesting an update configuration for its SRS transmission when there is a change in the operating conditions at the UE. Then, the UE may apply the positioning update without transition to an RRC connected state.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

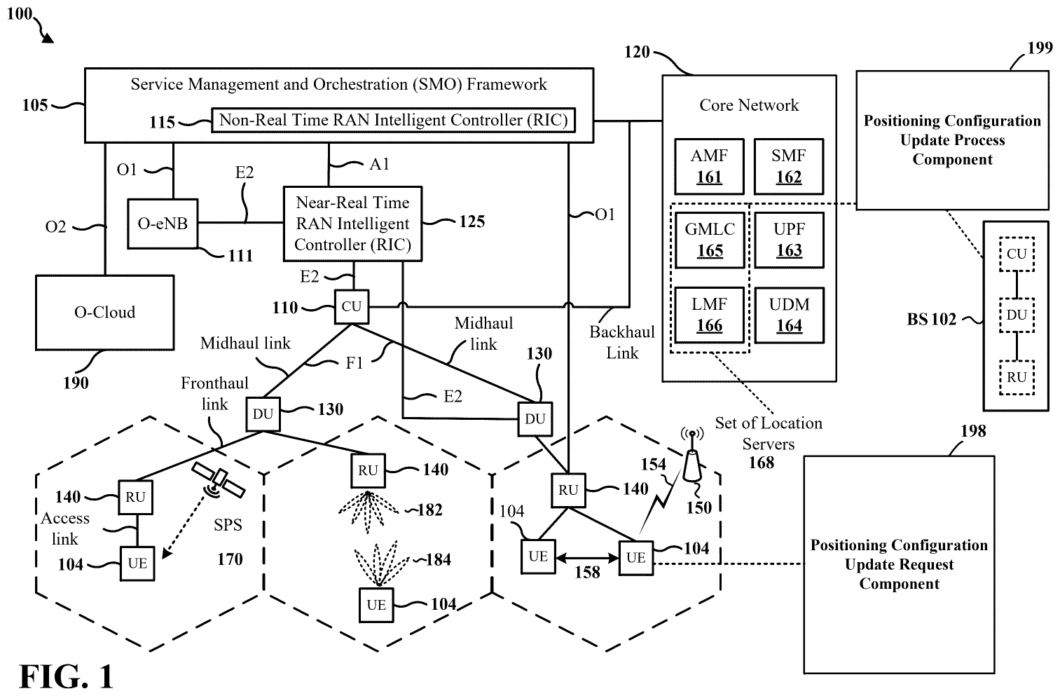

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to perform a set of measurements associated with a plurality of DL signals from a first network entity, where the set of measurements is performed during an RRC inactive state of the UE; transmit, based on the set of measurements for the plurality of DL signals, a request for an updated configuration for a set of SRS positioning resources to the first network entity; and receive an indication of the updated configuration for the set of SRS positioning resources based on the request via the positioning configuration update request component 198. In certain aspects, the base station 102 may be configured to receive a request for an updated configuration for a set of SRS positioning resources from a UE, where the request for the updated configuration for the set of SRS positioning resources is based on a set of measurements associated with a plurality of DL signals; and transmit an indication of at least one of: the updated configuration for the set of SRS positioning resources or a configuration for a CFRA procedure at a second network entity via the positioning configuration update process component 199.

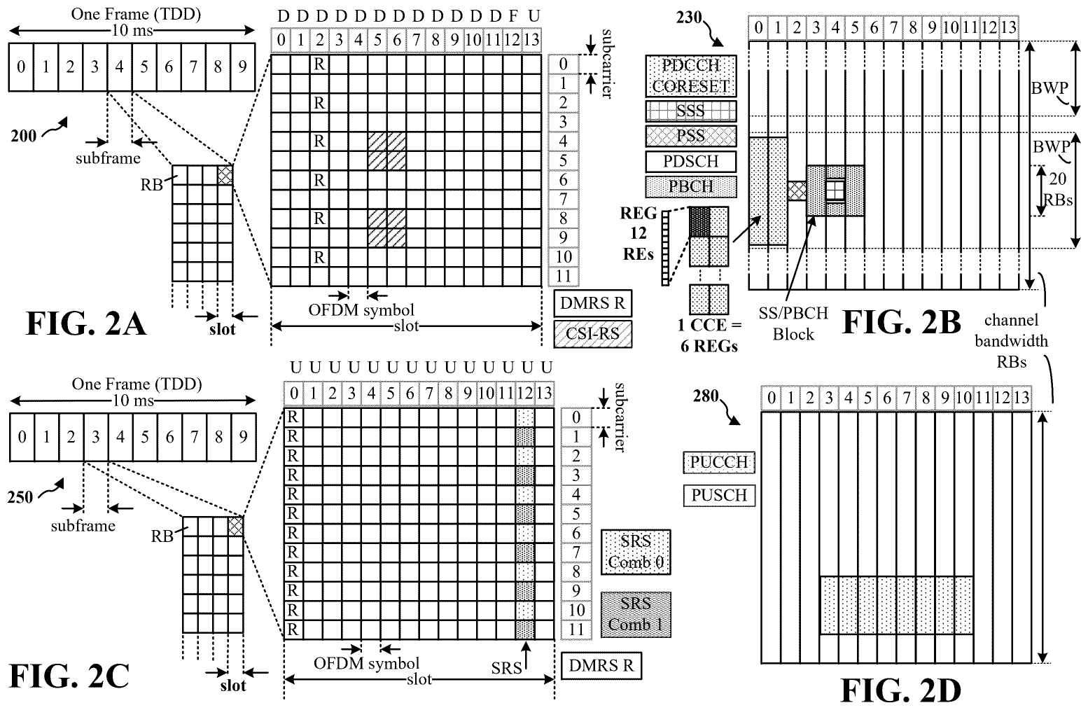

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

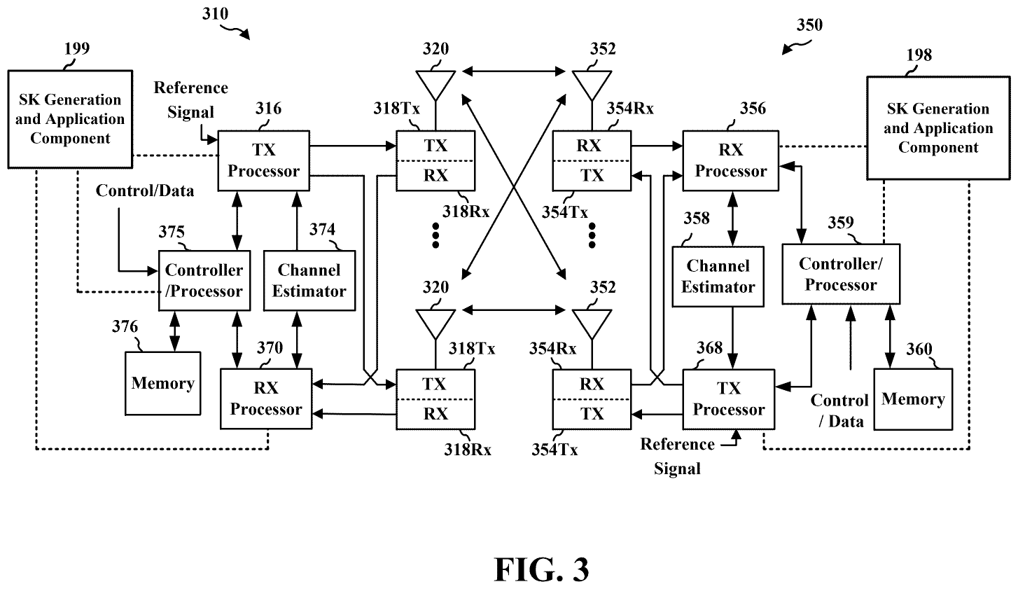

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning configuration update request component 198 of FIG. 1.

At least one of the TX processor 316, the RX processor 370, and the controller/processor 375 may be configured to perform aspects in connection with the positioning configuration update process component 199 of FIG. 1.

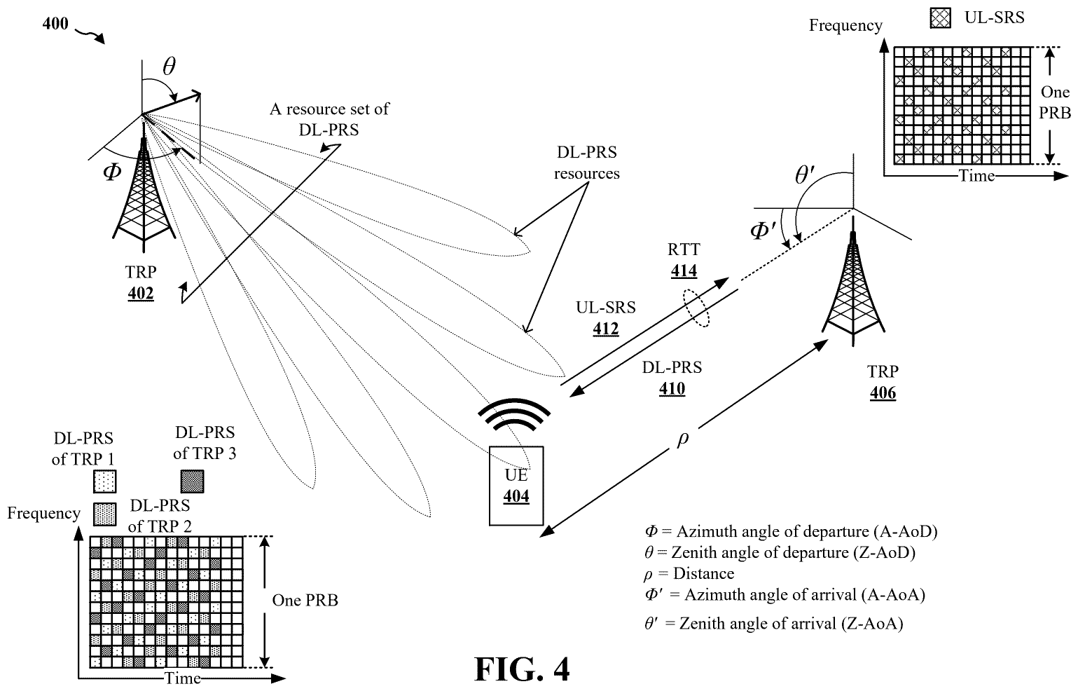

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

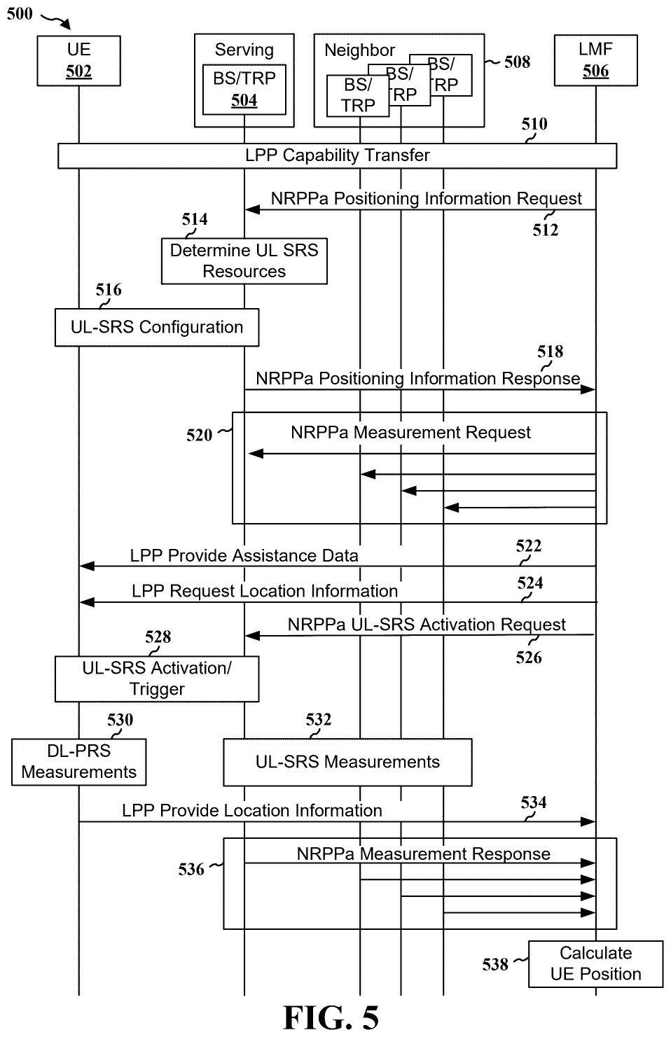

FIG. 5 is a communication flow 500 illustrating an example multi-RTT positioning procedure in accordance with various aspects of the present disclosure. The numberings associated with the communication flow 500 do not specify a particular temporal order and are merely used as references for the communication flow 500. In addition, a DL-only and/or an UL-only positioning may use a subset or subsets of this multi-RTT positioning procedure.

At 510, an LMF 506 may request one or more positioning capabilities from a UE 502 (e.g., from a target device). In some examples, the request for the one or more positioning capabilities from the UE 502 may be associated with an LTE Positioning Protocol (LPP). For example, the LMF 506 may request the positioning capabilities of the UE 502 using an LPP capability transfer procedure.

At 512, the LMF 506 may request UL SRS configuration information for the UE 502. The LMF 506 may also provide assistance data specified by a serving base station 504 (e.g., pathloss reference, spatial relation, and/or SSB configuration(s), etc.). For example, the LMF 506 may send an NR Positioning Protocol A (NRPPa) positioning information request message to the serving base station 504 to request UL information for the UE 502.

At 514, the serving base station 504 may determine resources available for UL SRS, and at 516, the serving base station 504 may configure the UE 502 with one or more UL SRS resource sets based on the available resources.

At 518, the serving base station 504 may provide UL SRS configuration information to the LMF 506, such as via an NRPPa positioning information response message.

At 520, the LMF 506 may select one or more candidate neighbor BSs/TRPs 508, and the LMF 506 may provide an UL SRS configuration to the one or more candidate neighbor BSs/TRPs 508 and/or the serving base station 504, such as via an NRPPa measurement request message. The message may include information for enabling the one or more candidate neighbor BSs/TRPs 508 and/or the serving base station to perform the UL measurements.

At 522, the LMF 506 may send an LPP provide assistance data message to the UE 502. The message may include specified assistance data for the UE 502 to perform the DL measurements.

At 524, the LMF 506 may send an LPP request location information message to the UE 502 to request multi-RTT measurements.

At 526, for semi-persistent or aperiodic UL SRS, the LMF 506 may request the serving base station 504 to activate/trigger the UL SRS in the UE 502. For example, the LMF 506 may request activation of UE SRS transmission by sending an NRPPa positioning activation request message to the serving base station 504.

At 528, the serving base station 504 may activate the UE SRS transmission and send an NRPPa positioning activation response message. In response, the UE 502 may begin the UL SRS transmission according to the time domain behavior of UL SRS resource configuration.

At 530, the UE 502 may perform the DL measurements from the one or more candidate neighbor BSs/TRPs 508 and/or the serving base station 504 provided in the assistance data. At 532, each of the configured one or more candidate neighbor BSs/TRPs 508 and/or the serving base station 504 may perform the UL measurements.

At 534, the UE 502 may report the DL measurements to the LMF 506, such as via an LPP provide location information message.

At 536, each of the one or more candidate neighbor BSs/TRPs 508 and/or the serving base station 504 may report the UL measurements to the LMF 506, such as via an NRPPa measurement response message.

At 538, the LMF 506 may determine the RTTs from the UE 502 and BS/TRP Rx-Tx time difference measurements for each of the one or more candidate neighbor BSs/TRPs 508 and/or the serving base station 504 for which corresponding UL and DL measurements were provided at 534 and 536, and the LMF 506 may calculate the position of the UE 502.

To minimize latency as well as to reduce signaling load, if there is no activity from a UE for a defined duration, the UE may suspend its session by transition to a radio resource control (RRC) inactive state. For example, after a random-access procedure, a UE may be in an RRC_connected state. The RRC protocol may be used on an air interface between a UE and a base station. The major functions of the RRC protocol may include connection establishment and release functions, broadcast of system information, radio bearer establishment, reconfiguration, and release, RRC connection mobility procedures, paging notification and release, and/or outer loop power control, etc. In some examples, such as in LTE, a UE may be in one of two RRC states (e.g., a connected state or an idle state). In other examples, such as in NR, a UE may be in one of three RRC states (e.g., a connected state, an idle state, or an inactive state). The different RRC states may have different radio resources associated with each state that a UE may use when the UE is in a given state. In some examples, the RRC states may also be referred to as RRC modes.

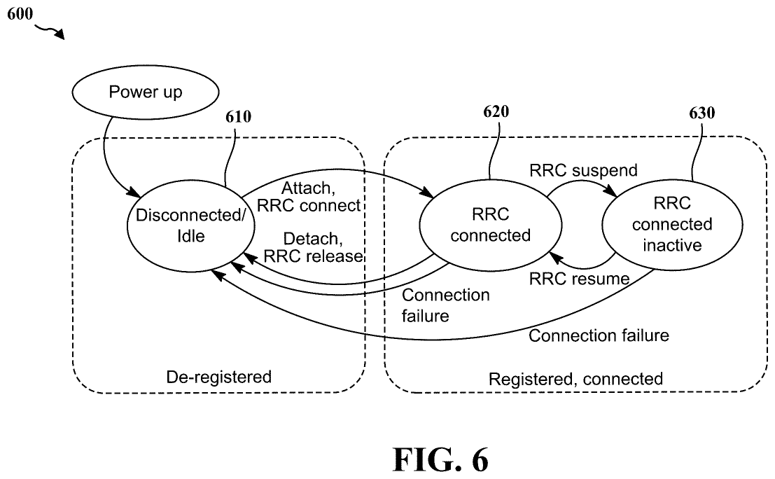

FIG. 6 is a diagram 600 illustrating an example of different RRC states in accordance with various aspects of the present disclosure. When a UE is powered up, the UE may initially be in an RRC disconnected/idle state 610. After a random access procedure, the UE may transition (or move) to an RRC connected state 620. If there is no activity at the UE for a defined duration, the UE may suspend its session by transitioning to an RRC inactive state 630. The UE may resume its session by performing a random access procedure to transition back to the RRC connected state 620. Thus, the UE may be specified to perform a random access procedure to transition to the RRC connected state 620, regardless of whether the UE is in the RRC idle state 610 or the RRC inactive state 630. As such, the RRC inactive state 630 may be a state between the RRC connected state 620 and the RRC disconnected/idle state 610 where the UE may stay in an inactive state without completely releasing the RRC when there is no traffic and quickly switch back to connected states when necessary.

In some examples, the RRC idle state 610 may be used for public land mobile network (PLMN) selection, broadcast of system information, cell re-selection mobility, paging for mobile terminated data (initiated and managed by the 5GC), and/or discontinuous reception (DRX) for core network paging (configured by non-access stratum (NAS)), etc. In other examples, the RRC connected state 620 may be used for 5GC and new RAN connection establishment (both control and user planes), UE context storage at the new RAN and the UE, new RAN knowledge of the cell to which the UE belongs, transfer of unicast data to/from the UE, and/or network controlled mobility, etc. In other examples, the RRC inactive state 630 may be used for the PLMN selection, broadcast of system information, cell re-selection for mobility, paging (initiated by the new RAN), RAN-based notification area (RNA) management (by the new RAN), DRX for RAN paging (configured by the new RAN), 5GC and new RAN connection establishment for the UE (both control and user planes), storage of the UE context in the new RAN and the UE, and/or new RAN knowledge of the RNA to which the UE belongs, etc.

In some scenarios, during a UE positioning session, a UE (e.g., the UE 404, 502) may also transition into the RRC inactive state to conserve radio and/or power resources while continuing to participate in the UE positioning session. For example, during a UE-assisted positioning session, a UE may transition into an RRC inactive state while continuing to measure DL PRS transmitted from a base station and report the DL PRS measurements to the base station or a location server. In one example, the UE may report the DL PRS measurements based on small data transmission (SDT) (or UL SDT). The SDT may refer to a transmission for a short data burst in a connectionless state where a UE is not specified to establish connections when small amounts of data or data below a size threshold is to be sent by the UE. In other words, SDT may enable a UE in an RRC inactive state to transmit infrequent and small data without specifying an RRC state transition.

For example, in some wireless communication network, uplink (UL) data generated in an RRC idle state of a UE may be transmitted by the UE after the UE transitions to an RRC connected state. The UE may transition from the RRC idle state to the RRC connected state transmitting an RRC resume request message to the serving base station. After transmission of the UL data, a UE in the RRC connected state may be specified to receive an RRC release message from a base station for transitioning back to the RRC idle state. This UL transmission mechanism may not be suitable for UL data below certain size(s) (e.g., which may be referred to as small data or SDT) as the overheads of the overall procedure are inefficient to transmit small amount of data (e.g., the size of the overheads may be larger than the data and/or the time it takes to transition the UE to RRC connected state may be longer than the actual data transmission, etc.). To improve the resource utilization, some wireless communication networks may include mechanisms for transmitting SDT without specifying the UE to transition to an RRC connected stated. For example, a wireless communication network may support early data transmission (EDT) and transmission using pre-configured uplink resource (PUR). The EDT may enable a UE device to receive UL grant for SDT in an RRC idle/inactive state via an random access procedure for the EDT. The UE in the RRC idle/inactive state may transmit UL small data using the uplink grant. The transmission using PUR allows SDT from an RRC idle/inactive state using PUR without performing a random access procedure. For purposes of the present disclosure, an UL SDT message may refer to a message with a size that qualifies as an SDT (e.g., the size is below certain threshold) and may be transmitted by a UE based on the EDT mechanism.

In addition, during a network-based positioning session, a UE may also be configured to transmit UL SRS while in an RRC inactive state. For example, an assistance data with SRS configuration may be provided to the UE while the UE is in the RRC connected state, and the UE may continue to transmit SRS based on the SRS configuration after transition to the RRC inactive state. In other words, the assistance data is provided when the UE is in RRC connected state and carries over to the RRC inactive state. However, if the UE moves to a different cell while in an RRC inactive state or if the RSRP measured by the UE changes by more than a threshold, the UE may be configured to suspend its SRS transmission. In other words, if there is a significant change in the operating conditions at the UE, then the UE may stop transmitting the SRS in the RRC inactive state. This may cause the positioning session of a UE to be interrupted, and the UE may be specified to transition into the RRC connected state for the UE positioning session to resume, which may increase the latency and reduce the efficiency of the UE positioning.

Aspects presented herein may improve the latency and efficiency of UE positioning. Aspects presented herein may enhance positioning configuration management for a UE and/or a positioning entity (e.g., a base station, a location server, etc.) while the UE is under an RRC inactive state. For example, aspects presented herein may enable a UE to request a positioning update during an RRC inactive state, such as requesting an update configuration for its SRS transmission when there is a change in the operating conditions at the UE. Then, the UE may apply the positioning update without transition to an RRC connected state.

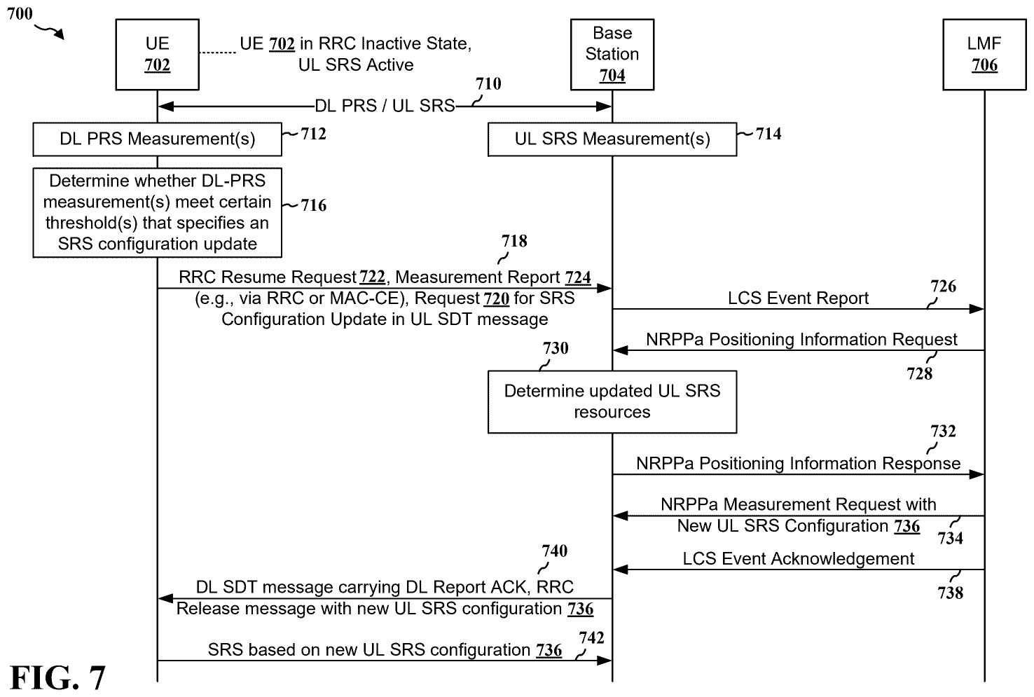

FIG. 7 is a communication flow 700 illustrating an example of a UE updating positioning configuration in an RRC inactive state in accordance with various aspects of the present disclosure. The numberings associated with the communication flow 700 do not specify a particular temporal order and are merely used as references for the communication flow 700. Aspects presented herein may enable a UE to send an RRC message to a base station requesting for an updated UL SRS configuration when the UE is in an RRC inactive state and SDT is configured for the UE. For example, the UE may send updated (e.g., current) measurements associated with signals received from a base station via an UL SDT message, such as L1-RSRP, intra and inter-frequency measurements (e.g., SSB measurements for radio resource management (RRM) and/or CSI-RS or PRS measurements), etc. In response, the base station may respond back with an updated UL SRS configuration based on the measurements, where the updated UL SRS configuration may be better matched to the UE's current operating condition.

At 710, a UE 702 that is under an RRC inactive state may be configured to continue exchanging positioning reference signals with a base station 704. For example, the UE 702 may continue to transmit UL SRS to the base station 704 and receive DL PRS from the base station 704, such as described above.

At 712, the UE 702 may perform measurements for the DL PRS received from the base station 704, such as measuring the RSRP for the DL PRS (e.g., may be for purposes of determining/estimating channel condition(s) between the UE 702 and the base station 704). Similarly, at 714, the base station 704 may also perform measurement for the UL SRS received from the UE 702.

At 716, based on the DL PRS measurement(s), the UE 702 may determine whether PRS measurement(s) meet certain threshold(s) or condition(s) that specifies that UE 702 to update its UL SRS configuration, such as changing the transmission (Tx) power of the UL SRS, the periodicity of the UL SRS, the Tx beam used for the UL SRS, the direction of the Tx beam, and/or the resources (e.g., time and/or frequency resources) for transmitting the UL SRS, etc. The determination may be based on channel reciprocity, where the UE 702 may estimate the UL channel from the sounding on the DL channel (e.g., the channel conditions between the DL channel and the UL channel are likely to be similar). For example, after measuring the DL PRS from the base station 704, the UE 702 may determine whether the RSRP falls below an RSRP threshold.

In another example, if there is a change in the operating conditions at the UE 702, the UE 702 may also determine that an UL SRS configuration update is specified. For example, when the UE 702 moves to a different location (or moves by a predefined distance), the power of the UE 702 falls below certain power threshold/level, and/or the UE 702 is experiencing a high level interference, the UE 702 may determine that an update for its UL SRS configuration is specified.

At 718, based on the determination that an UL SRS configuration update is specified, the UE 702 may transmit a request 720 for an UL SRS configuration update to the base station 704 in an UL SDT message. In addition, the UE 702 may also transmit an RRC resume request 722 and/or a measurement report 724 associated with DL PRS measurements performed at 712 to the base station 704 (e.g., also via the UL SDT message or one or more other messages). The measurement report 724 may be transmitted to the base station 704 via an RRC signaling or a medium access control (MAC)-control element (CE) (MAC-CE).

At 726, the base station 704 may transmit/forward the request 720 from the UE 702 to an LMF 706, such as via a location services (LCS) event report. At 728, in response to the request 720, the LMF 706 may request the base station 704 to configure UL SRS resources for the UE 702. The LMF 706 may also provide assistance data specified by the base station 704.

At 730, the base station 704 may determine updated UL SRS resources available for the UE 702. Then, at 732, the base station 704 may report the determined updated UL SRS resources to the LMF 706. In response, at 734, the LMF 706 may provide a new UL SRS configuration 736 to the base station 704.

At 738, the LMF 706 may also transmit an acknowledgement for the request 720 to the base station 704, such as via an LCS event acknowledgement message (e.g., in response to the LCS event report).

At 740, based on the new UL SRS configuration 736 received from the LMF 706, the base station 704 may send the new UL SRS configuration 736 to the UE 702, such as via a DL SDT message. In addition, the DL SDT message may also carry a DL report acknowledgement (e.g., in response to the measurement report 724 received at 718) and an RRC release message (e.g., in response to the RRC resume request 722 received at 718). For purposes of the present disclosure, this new UL SRS configuration 736 may also be referred to as an updated SRS configuration or an updated configuration for SRS positioning resources, etc. As such updated configuration may refer to a configuration that includes one or more updated parameters (e.g., updated SRS parameters) that are different from a prior configuration (e.g., original/current SRS parameters).

At 742, after receiving the new UL SRS configuration 736 from the base station 704, the UE 702 may transmit UL SRS based on the new UL SRS configuration 736 (and also based on the UL SRS resources determined by the base station 704 at 730).

As such, aspects presented herein may enable a UE to request a modification to its SRS configuration during an RRC inactive state without transitioning to an RRC connected state, thereby improving the latency and efficiency of the positioning configuration management.

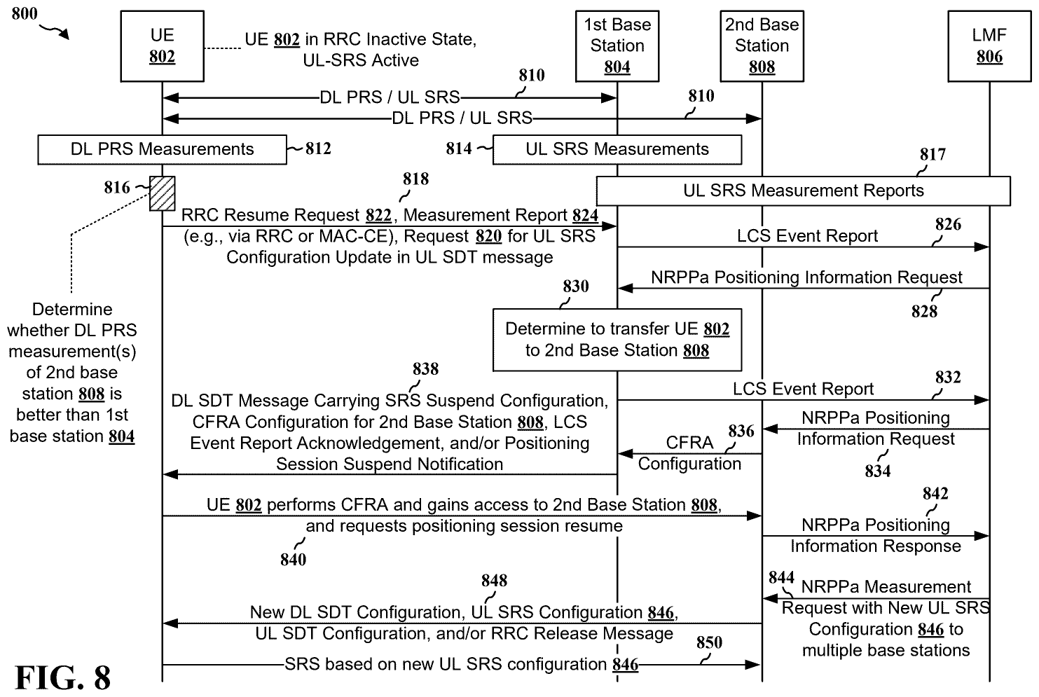

FIG. 8 is a communication flow 800 illustrating an example of a UE updating positioning configuration in an RRC inactive state after switching to a new base station in accordance with various aspects of the present disclosure. The numberings associated with the communication flow 800 do not specify a particular temporal order and are merely used as references for the communication flow 800. Aspects presented herein may enable a UE to send an RRC message to a first base station requesting to switch from the first base station to a second base station and requesting for an updated UL SRS configuration from the second base station when the UE is in an RRC inactive state and SDT is configured for the UE.

For example, a UE may measure DL PRSs from a first base station and a second base station while the UE is under an RRC inactive state, and the UE may determine that the second base station has better DL PRS measurements (e.g., channel conditions, RSRP, etc.) compared to the first base station. As such, based on the determination, the UE may send an UL SRS configuration update request in an UL SDT message which may also include an indication for a request to switch from the first base station to the second base station. In response, the first base station may respond the UE with a contention-free random access (CFRA) resource for the second base station, where the UE may use the CFRA resource to access the second base station and the second base station may provide a new RRC inactive state configuration for the UE in a DL SDT message. The DL SDT message from the second base station may be scrambled with a pre-determined radio network temporary identifier (RNTI) by the first base station (e.g., based on inter-cell coordination performed at the network side). Then, the DL SDT message from the second base station may indicate a new DL SDT configuration, a new UL SRS configuration, and/or a new UL SDT configuration for the UE.

Some wireless communication networks may enable a UE to access a base station based on contention based random access (CBRA) or CFRA procedure. CFRA may refer to a mode which a UE may initially use to perform a random access (RA) procedure in a non-standalone (NSA) mode. The UE may use an assigned preamble to perform RA and the procedure finishes once the UE receives an random access response (RAR). CBRA is the fallback scenario in the NSA mode. If CFRA fails e.g. if the transmission of the dedicated preamble is not acknowledged, within a configured time period, then UE may switch to CBRA to establish UL synchronization. CFRA may typically be applied when the UE is in an RRC connected mode.

At 810, a UE 802 that is under an RRC inactive state may be configured to continue exchanging positioning reference signals with multiple base stations, which may include a first base station 804 and a second base station 808. For example, the UE 802 may continue to transmit UL SRS to the first base station 804 and the second base station 808, and receive DL PRS from the first base station 804 and the second base station 808.

At 812, the UE 802 may perform measurements for the DL PRS received from the first base station 804 and the second base station 808, such as measuring the RSRP for the DL PRS (e.g., may be for purposes of determining/estimating channel condition(s) between the UE 802 and the base stations). Similarly, at 814, the first base station 804 and the second base station 808 may also perform measurement for the UL SRS received from the UE 802.

At 816, based on the DL PRS measurement(s), the UE 802 may determine whether PRS measurement(s) from a base station meet certain threshold(s) or condition(s) that specifies the UE 802 to change to another base station (e.g., to switch its access to another base station) and to update its UL SRS configuration accordingly, such as changing the Tx power of the UL SRS, the periodicity of the UL SRS, the Tx beam used for the UL SRS, the direction of the Tx beam, and/or the resources (e.g., time and/or frequency resources) for transmitting the UL SRS, etc. For example, after measuring the RSRP of DL PRS from the first base station 804 and the second base station 808, the UE 802 may determine that the measured RSRP for the first base station 804 falls below an RSRP threshold and/or that the measured RSRP for the second base station 808 is higher than the first base station 804 (e.g., by a threshold). As such, the UE 802 may determine to switch its access to the second base station 808 from the first base station 804, which may specify a new UL SRS configuration for transmitting the SRS to the second base station 808. In another example, if there is a change in the operating conditions at the UE 802, the UE 802 may also determine that a base station switching and an UL SRS configuration update are specified. For example, when the UE 802 moves from a cell associated with the first base station 804 to a cell associated with the second base station 808, the UE 802 may determine to switch to the second base station 808 and request an UL SRS configuration update from the second base station 808.

At 818, based on the determination that a base station switching (e.g., from the first base station 804 to the second base station 808) and an UL SRS configuration update are specified, the UE 802 may transmit a request 820 for an UL SRS configuration update to the first base station 804 in an UL SDT message, where the request 820 may also include an indication regarding switching from the first base station 804 to the second base station 808. In one example, the indication to switch from the first base station 804 to the second base station 808 may be explicit, where the UE 802 may determine that a base station switching is specified and explicitly request the first base station 804 to handover the UE 802 to the second base station 808. In another example, the indication to switch from the first base station 804 to the second base station 808 may be implicit, where the UE 802 may transmit DL PRS measurements of the first base station 804 and the second base station 808 to the first base station 804. Based on the DL PRS measurements, the first base station 804 may determine that the second base station 808 is more suitable for serving the UE 802, and the first base station 804 may determine to handover the UE 802 to the second base station 808. In addition, the UE 802 may transmit an RRC resume request 822 and/or a measurement report 824 associated with DL PRS measurements performed at 812 to the first base station 804 via the UL SDT message. The measurement report 824 may be transmitted to the first base station 804 via an RRC signaling or a MAC-CE.

In another aspect of the present disclosure, as shown at 817, the switching of base station may also be determined by an LMF 806. For example, the first base station 804 and the second base station 808 may transmit their UL SRS measurements to the LMF 806. Based on the UL SRS measurements, the LMF 806 may determine that the second base station 808 is more suitable for serving the UE 802 compared to the first base station 804, and the LMF 806 may determine to handover the UE 802 from the first base station 804 to the second base station 808.

At 826, the first base station 804 may transmit/forward the request 820 from the UE 802 to the LMF 806, such as via an LCS event report. At 828, the LMF may respond to the request 820, such as via an NRPPa positioning information request message.

At 830, the first base station 804 may determine to handover (e.g., transfer) the UE 802 to the second base station 808. The determination may be based on the request 820 from the UE 802 (e.g., the explicit indication from the UE 802), based on the first base station 804's own determination (e.g., the implicit indication from the UE 802), or based on the determination from the LMF 806 (e.g., as described at 817).

At 832, the first base station 804 may notify the LMF 806 regarding the determination to handover the UE 802 to the second base station 808, such as via an LCS event report message. At 834, in response to the notification from the first base station 804, the LMF 806 may inform the second base station 808 regarding the determination to handover the UE 802 to the second base station 808, such as via an NRPPa positioning information response message.

At 836, after receiving determination to handover the UE 802 to the second base station 808, the second base station 808 may generate a CFRA configuration which may be used by the UE 802 for accessing the second base station 808, and the second base station may 808 may transmit the CFRA configuration to the first base station 804. Under CFRA, a preamble may be allocated by a base station and such preamble may be known as a dedicated random access preamble. The dedicated preamble may be provided to a UE either via RRC signaling (allocating preamble may be specified within an RRC message) or PHY Layer signaling (e.g., DCI on the PDCCH). Therefore, there may be no preamble conflict.

At 838, after receiving the CFRA configuration from the second base station 808, the first base station 804 may transmit the CFRA configuration to the UE 802 via a DL SDT message. In addition, the DL SDT message may further include an SRS suspend configuration (e.g., informing the UE 802 to suspend the SRS transmission to the first base station 804), an acknowledgement for the request 820 (e.g., an LCS event report acknowledgement), and/or a positioning session suspend notification (e.g., informing the UE 802 to suspend the positioning session during the handover procedure), etc.

At 840, based on the CFRA configuration received, the UE 802 may perform CFRA procedure with the second base station 808 and gain access to the second base station 808. In addition, the UE 802 may transmit a positioning session resume request to the second base station 808 to resume the suspended positioning session (e.g., after receiving the positioning session suspend notification at 838) based on the CFRA procedure.

At 842, the base station 808 may inform the LMF 806 regarding the completion of handover (e.g., that the UE 802 has gained access to the second base station 808). In response, at 844, the LMF 806 may provide a new UL SRS configuration 846 to multiple base stations participating in the positioning session including the second base station 808, such as via an NRPPa measurement request message as described in connection with 520 of FIG. 5.

At 848, based on the new UL SRS configuration 846 received from the LMF 806, the second base station 808 may send the new UL SRS configuration 846 to the UE 802, such as via an RRC release message. In addition, the RRC release message may also carry a new DL SDT configuration (e.g., for the UE 802 to receive DL SDT message from the second base station 808) and/or a new UL SDT configuration (e.g., for the UE 802 to transmit UL SDT message to the second base station 808). Examples of DL/UL SDT configuration may include the time and frequency resources, periodicity, and/or offset for DL/UL SDT, etc.

At 850, after receiving the new UL SRS configuration 846 from the first base station 804, the UE 802 may transmit UL SRS based on the new UL SRS configuration 846 (and also based on the UL SRS resources determined by the second base station 808).

As such, aspects presented herein may enable a UE to switch its access to a new base station and request an SRS configuration update for the new base station during an RRC inactive state without transitioning to an RRC connected state, thereby improving the latency and efficiency of the positioning configuration management.

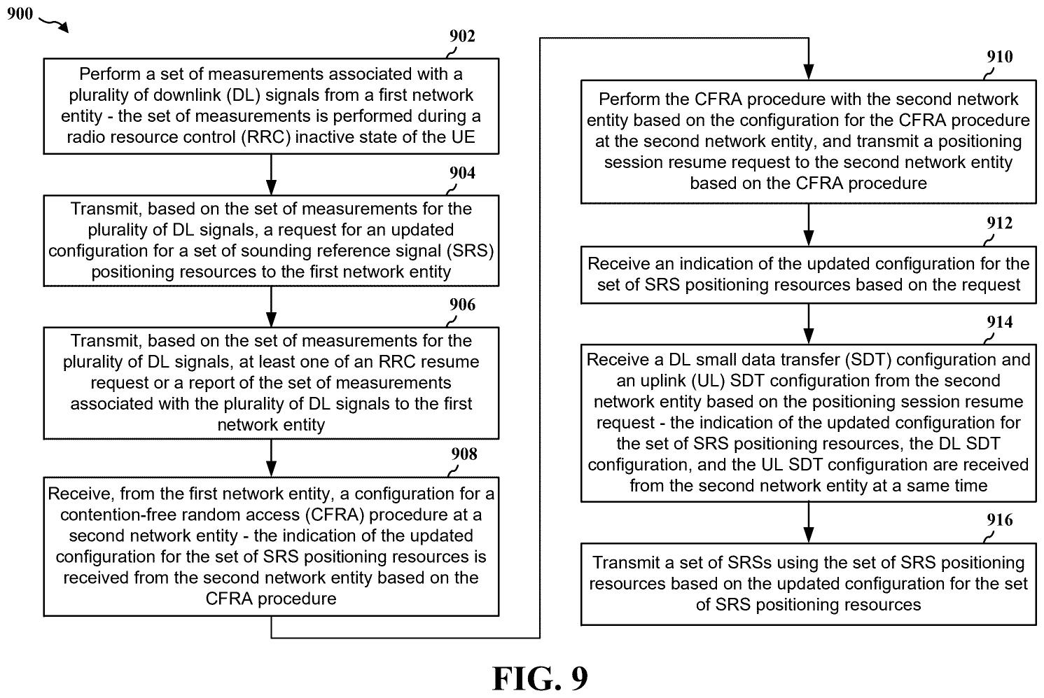

FIG. 9 is a flowchart 900 of a method of wireless communication. The method may be performed by a UE (e.g., the UE 104, 404, 502, 702, 802; the apparatus 1104). The method may enable the UE to request a positioning update during an RRC inactive state, such as requesting an update configuration for its SRS transmission when there is a change in the operating conditions at the UE. Then, the UE may apply the positioning update without transition to an RRC connected state.

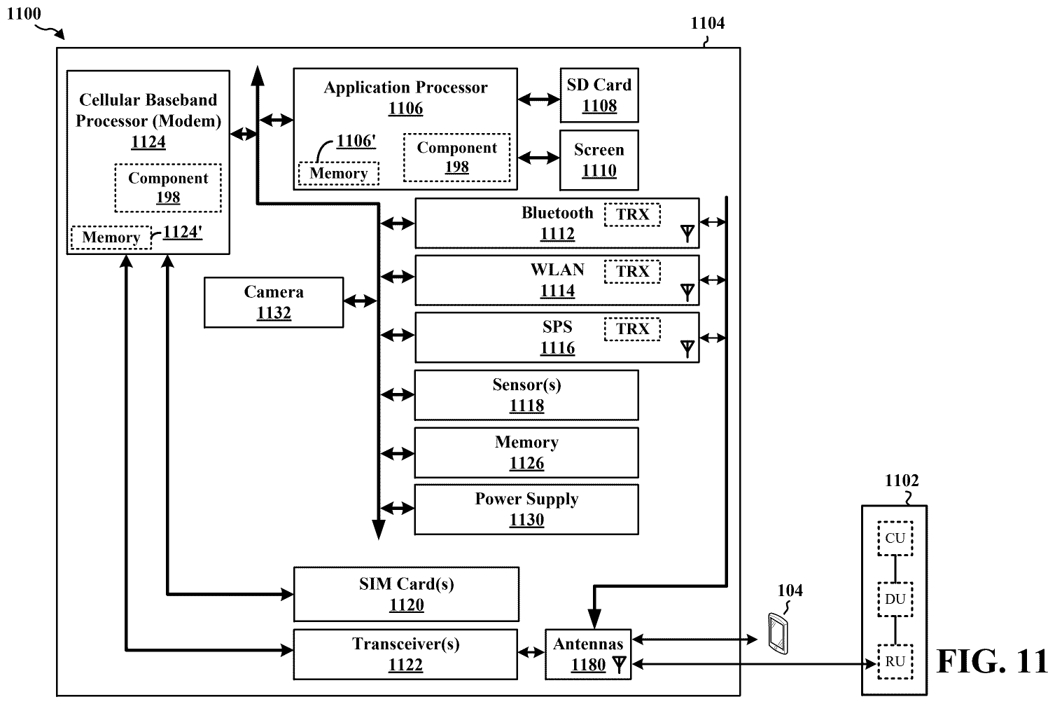

At 902, the UE may perform a set of measurements associated with a plurality of DL signals from a first network entity, where the set of measurements is performed during an RRC inactive state of the UE, such as described in connection with FIGS. 7 and 8. For example, at 810 of FIG. 8, the UE 802 may measure DL PRSs from the first base station 804 during an RRC inactive state of the UE 802. The measurement of the plurality of DL signals may be performed by, e.g., the positioning configuration update request component 198 and/or the transceiver(s) 1122 of the apparatus 1104 in FIG. 11.

In one example, the plurality of DL signals includes DL-PRS, SIBs, CSI-RS, DM-RS, or a combination thereof.

At 904, the UE may transmit, based on the set of measurements for the plurality of DL signals, a request for an updated configuration for a set of SRS positioning resources to the first network entity, such as described in connection with FIGS. 7 and 8. For example, at 818 of FIG. 8, the UE 802 may transmit, based on the measurements for the DL PRS from the first base station 804, a request 820 for UL SRS configuration update to the first base station 804. The transmission of the request may be performed by, e.g., the positioning configuration update request component 198 and/or the transceiver(s) 1122 of the apparatus 1104 in FIG. 11.

In one example, the request for the updated configuration for the set of SRS positioning resources is transmitted via an UL SDT message. In such an example, the UL SDT message may further include a set of L1-RSRP measurements, a set of intra-frequency positioning measurements, or a set of inter-frequency positioning measurements, or a combination thereof.

At 906, the UE may transmit, based on the set of measurements for the plurality of DL signals, at least one of an RRC resume request or a report of the set of measurements associated with the plurality of DL signals to the first network entity, such as described in connection with FIGS. 7 and 8. For example, at 818 of FIG. 8, the UE 802 may further transmit at least one of an RRC resume request 822 or measurement report 824 for DL PRSs to the first base station 804. The transmission of the RRC resume request and/or the report may be performed by, e.g., the positioning configuration update request component 198 and/or the transceiver(s) 1122 of the apparatus 1104 in FIG. 11.

In one example, the report of the set of measurements associated with the plurality of DL signals is transmitted to the first network entity via RRC signaling or a MAC-CE.

At 908, the UE may receive, from the first network entity, a configuration for a CFRA procedure at a second network entity, where the indication of the updated configuration for the set of SRS positioning resources is received from the second network entity based on the CFRA procedure, such as described in connection with FIG. 8. For example, at 838 of FIG. 8, the UE 802 may receive, from the first base station 804, a CFRA configuration for the second base station 808, where the UL SRS configuration update is received from the second base station 808 based on the CFRA procedure. The reception of the configuration for the CFRA procedure may be performed by, e.g., the positioning configuration update request component 198 and/or the transceiver(s) 1122 of the apparatus 1104 in FIG. 11.

At 910, the UE may perform the CFRA procedure with the second network entity based on the configuration for the CFRA procedure at the second network entity, and the UE may transmit a positioning session resume request to the second network entity based on the CFRA procedure, such as described in connection with FIG. 8. For example, at 840 of FIG. 8, the UE 802 may perform CFRA and gain access to the second base station 808, and transmit a request to resume positioning session to the second base station 808. The CFRA procedure may be performed by, e.g., the positioning configuration update request component 198 and/or the transceiver(s) 1122 of the apparatus 1104 in FIG. 11.

In one example, the indication of the updated configuration for the set of SRS positioning resources is received from the second network entity based on the positioning session resume request.

At 912, the UE may receive an indication of the updated configuration for the set of SRS positioning resources based on the request, such as described in connection with FIGS. 7 and 8. For example, at 848 of FIG. 8, the UE 802 may receive UL SRS configuration 846 from the second base station 808. The reception of the indication of the updated configuration for the set of SRS positioning resources may be performed by, e.g., the positioning configuration update request component 198 and/or the transceiver(s) 1122 of the apparatus 1104 in FIG. 11.

In one example, the indication of the updated configuration for the set of SRS positioning resources is received from the first network entity.

At 914, the UE may receive a DL SDT configuration and an UL SDT configuration from the second network entity based on the positioning session resume request, where the indication of the updated configuration for the set of SRS positioning resources, the DL SDT configuration, and the UL SDT configuration are received from the second network entity at a same time, such as described in connection with FIG. 8. For example, at 848 of FIG. 8, the UE 802 may receive a DL SDT configuration and an UL SDT configuration from the second base station 808 based on the positioning session resume request, where the UL SRS configuration 846, the DL SDT configuration, and the UL SDT configuration may be received from the second base station 808 at the same time. The reception of the DL SDT configuration and the UL SDT configuration may be performed by, e.g., the positioning configuration update request component 198 and/or the transceiver(s) 1122 of the apparatus 1104 in FIG. 11.

In one example, the indication of the updated configuration for the set of SRS positioning resources, the DL SDT configuration, and the UL SDT configuration are received from the second network entity in an RRC release message.

At 916, the UE may transmit a set of SRSs using the set of SRS positioning resources based on the updated configuration for the set of SRS positioning resources, such as described in connection with FIGS. 7 and 8. For example, at 850 of FIG. 8, the UE 802 may transmit SRSs based on the new UL SRS configuration 846. The transmission of the set of SRSs may be performed by, e.g., the positioning configuration update request component 198 and/or the transceiver(s) 1122 of the apparatus 1104 in FIG. 11.

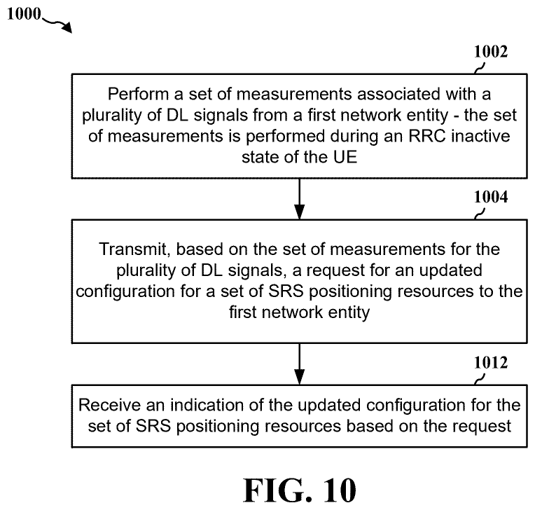

FIG. 10 is a flowchart 1000 of a method of wireless communication. The method may be performed by a UE (e.g., the UE 104, 404, 502, 702, 802; the apparatus 1104). The method may enable the UE to request a positioning update during an RRC inactive state, such as requesting an update configuration for its SRS transmission when there is a change in the operating conditions at the UE. Then, the UE may apply the positioning update without transition to an RRC connected state.

At 1002, the UE may perform a set of measurements associated with a plurality of DL signals from a first network entity, where the set of measurements is performed during an RRC inactive state of the UE, such as described in connection with FIGS. 7 and 8. For example, at 810 of FIG. 8, the UE 802 may measure DL PRSs from the first base station 804 during an RRC inactive state of the UE 802. The measurement of the plurality of DL signals may be performed by, e.g., the positioning configuration update request component 198 and/or the transceiver(s) 1122 of the apparatus 1104 in FIG. 11.

In one example, the plurality of DL signals includes DL-PRS, SIBs, CSI-RS, DM-RS, or a combination thereof.

At 1004, the UE may transmit, based on the set of measurements for the plurality of DL signals, a request for an updated configuration for a set of SRS positioning resources to the first network entity, such as described in connection with FIGS. 7 and 8. For example, at 818 of FIG. 8, the UE 802 may transmit, based on the measurements for the DL PRS from the first base station 804, a request 820 for UL SRS configuration update to the first base station 804. The transmission of the request may be performed by, e.g., the positioning configuration update request component 198 and/or the transceiver(s) 1122 of the apparatus 1104 in FIG. 11.

In one example, the request for the updated configuration for the set of SRS positioning resources is transmitted via an UL SDT message. In such an example, the UL SDT message may further include a set of L1-RSRP measurements, a set of intra-frequency positioning measurements, or a set of inter-frequency positioning measurements, or a combination thereof.

In another example, the UE may transmit, based on the set of measurements for the plurality of DL signals, at least one of an RRC resume request or a report of the set of measurements associated with the plurality of DL signals to the first network entity, such as described in connection with FIGS. 7 and 8. For example, at 818 of FIG. 8, the UE 802 may further transmit at least one of an RRC resume request 822 or measurement report 824 for DL PRSs to the first base station 804. The transmission of the RRC resume request and/or the report may be performed by, e.g., the positioning configuration update request component 198 and/or the transceiver(s) 1122 of the apparatus 1104 in FIG. 11. In such an example, the report of the set of measurements associated with the plurality of DL signals is transmitted to the first network entity via RRC signaling or a MAC-CE.

In another example, the UE may receive, from the first network entity, a configuration for a CFRA procedure at a second network entity, where the indication of the updated configuration for the set of SRS positioning resources is received from the second network entity based on the CFRA procedure, such as described in connection with FIG. 8. For example, at 838 of FIG. 8, the UE 802 may receive, from the first base station 804, a CFRA configuration for the second base station 808, where the UL SRS configuration update is received from the second base station 808 based on the CFRA procedure. The reception of the configuration for the CFRA procedure may be performed by, e.g., the positioning configuration update request component 198 and/or the transceiver(s) 1122 of the apparatus 1104 in FIG. 11.

In another example, the UE may perform the CFRA procedure with the second network entity based on the configuration for the CFRA procedure at the second network entity, and the UE may transmit a positioning session resume request to the second network entity based on the CFRA procedure, such as described in connection with FIG. 8. For example, at 840 of FIG. 8, the UE 802 may perform CFRA and gain access to the second base station 808, and transmit a request to resume positioning session to the second base station 808. The CFRA procedure may be performed by, e.g., the positioning configuration update request component 198 and/or the transceiver(s) 1122 of the apparatus 1104 in FIG. 11. In such an example, the indication of the updated configuration for the set of SRS positioning resources is received from the second network entity based on the positioning session resume request.

At 1012, the UE may receive an indication of the updated configuration for the set of SRS positioning resources based on the request, such as described in connection with FIGS. 7 and 8. For example, at 848 of FIG. 8, the UE 802 may receive UL SRS configuration 846 from the second base station 808. The reception of the indication of the updated configuration for the set of SRS positioning resources may be performed by, e.g., the positioning configuration update request component 198 and/or the transceiver(s) 1122 of the apparatus 1104 in FIG. 11.

In one example, the indication of the updated configuration for the set of SRS positioning resources is received from the first network entity.

In another example, the UE may receive a DL SDT configuration and an UL SDT configuration from the second network entity based on the positioning session resume request, where the indication of the updated configuration for the set of SRS positioning resources, the DL SDT configuration, and the UL SDT configuration are received from the second network entity at a same time, such as described in connection with FIG. 8. For example, at 848 of FIG. 8, the UE 802 may receive a DL SDT configuration and an UL SDT configuration from the second base station 808 based on the positioning session resume request, where the UL SRS configuration 846, the DL SDT configuration, and the UL SDT configuration may be received from the second base station 808 at the same time. The reception of the DL SDT configuration and the UL SDT configuration may be performed by, e.g., the positioning configuration update request component 198 and/or the transceiver(s) 1122 of the apparatus 1104 in FIG. 11. In such an example, the indication of the updated configuration for the set of SRS positioning resources, the DL SDT configuration, and the UL SDT configuration are received from the second network entity in an RRC release message.

In another example, the UE may transmit a set of SRSs using the set of SRS positioning resources based on the updated configuration for the set of SRS positioning resources, such as described in connection with FIGS. 7 and 8. For example, at 850 of FIG. 8, the UE 802 may transmit SRSs based on the new UL SRS configuration 846. The transmission of the set of SRSs may be performed by, e.g., the positioning configuration update request component 198 and/or the transceiver(s) 1122 of the apparatus 1104 in FIG. 11.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to perform a set of measurements associated with a plurality of DL signals from a first network entity, here the set of measurements is performed during an RRC inactive state of the UE; transmit, based on the set of measurements for the plurality of DL signals, a request for an updated configuration for a set of SRS positioning resources to the first network entity; and receive an indication of the updated configuration for the set of SRS positioning resources based on the request. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for performing a set of measurements associated with a plurality of DL signals from a first network entity, where the set of measurements is performed during an RRC inactive state of the UE. The apparatus 1104 may also include means for transmitting, based on the set of measurements for the plurality of DL signals, a request for an updated configuration for a set of SRS positioning resources to the first network entity. The apparatus 1104 may also include means for receiving an indication of the updated configuration for the set of SRS positioning resources based on the request.

In one configuration, the plurality of DL signals includes DL-PRS, SIBs, CSI-RS, DM-RS, or a combination thereof.

In another configuration, the request for the updated configuration for the set of SRS positioning resources is transmitted via an UL SDT message. In such a configuration, the UL SDT message may further include a set of L1-RSRP measurements, a set of intra-frequency positioning measurements, or a set of inter-frequency positioning measurements, or a combination thereof.

In another configuration, the apparatus 1104 may also include means for transmitting, based on the set of measurements for the plurality of DL signals, at least one of an RRC resume request or a report of the set of measurements associated with the plurality of DL signals to the first network entity. In such a configuration, the report of the set of measurements associated with the plurality of DL signals is transmitted to the first network entity via RRC signaling or a MAC-CE.

In another configuration, the apparatus 1104 may also include means for receiving, from the first network entity, a configuration for a CFRA procedure at a second network entity, where the indication of the updated configuration for the set of SRS positioning resources is received from the second network entity based on the CFRA procedure.

In another configuration, the apparatus 1104 may also include means for performing the CFRA procedure with the second network entity based on the configuration for the CFRA procedure at the second network entity. The apparatus 1104 may also include means for transmitting a positioning session resume request to the second network entity based on the CFRA procedure. In such a configuration, the indication of the updated configuration for the set of SRS positioning resources is received from the second network entity based on the positioning session resume request.

In another configuration, the indication of the updated configuration for the set of SRS positioning resources is received from the first network entity.

In another configuration, the apparatus 1104 may also include means for receiving a DL SDT configuration and an UL SDT configuration from the second network entity based on the positioning session resume request, where the indication of the updated configuration for the set of SRS positioning resources, the DL SDT configuration, and the UL SDT configuration are received from the second network entity at a same time. In such a configuration, the indication of the updated configuration for the set of SRS positioning resources, the DL SDT configuration, and the UL SDT configuration are received from the second network entity in an RRC release message.

In another configuration, the apparatus 1104 may also include means for transmitting a set of SRSs using the set of SRS positioning resources based on the updated configuration for the set of SRS positioning resources.

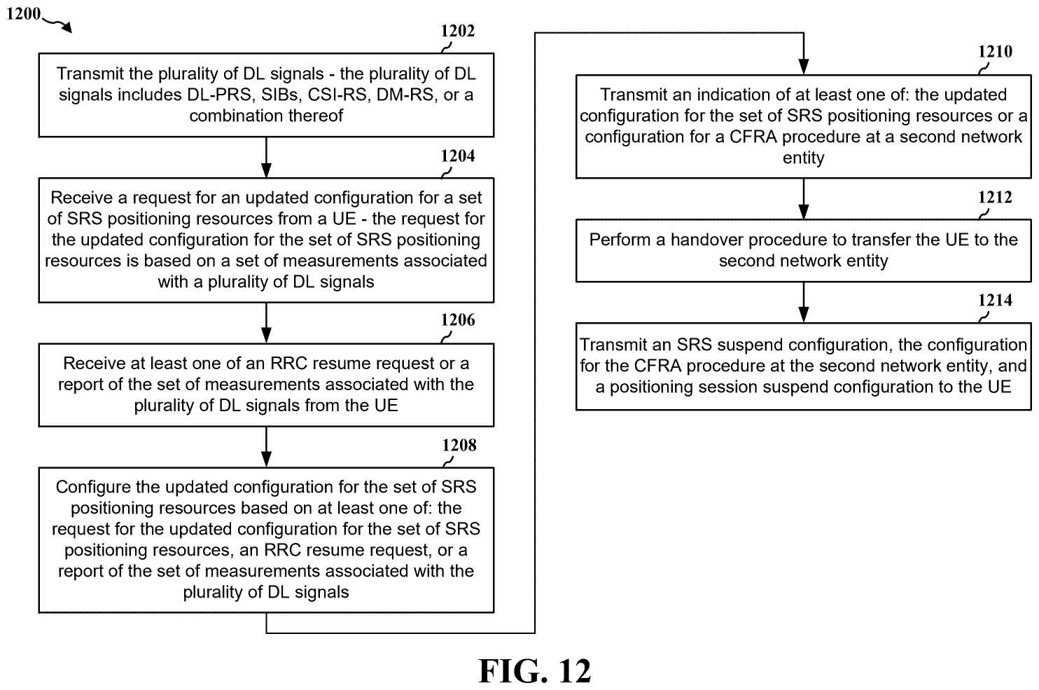

FIG. 12 is a flowchart 1200 of a method of wireless communication. The method may be performed by a first base station (e.g., the base station 102, 704, 804, 808; the network entity 1402. The method may enable the first base station to receive a request for a positioning update from a UE during an RRC inactive state of the UE, and to provide a positioning update to the UE or to handover the UE to a second base station based on the request.

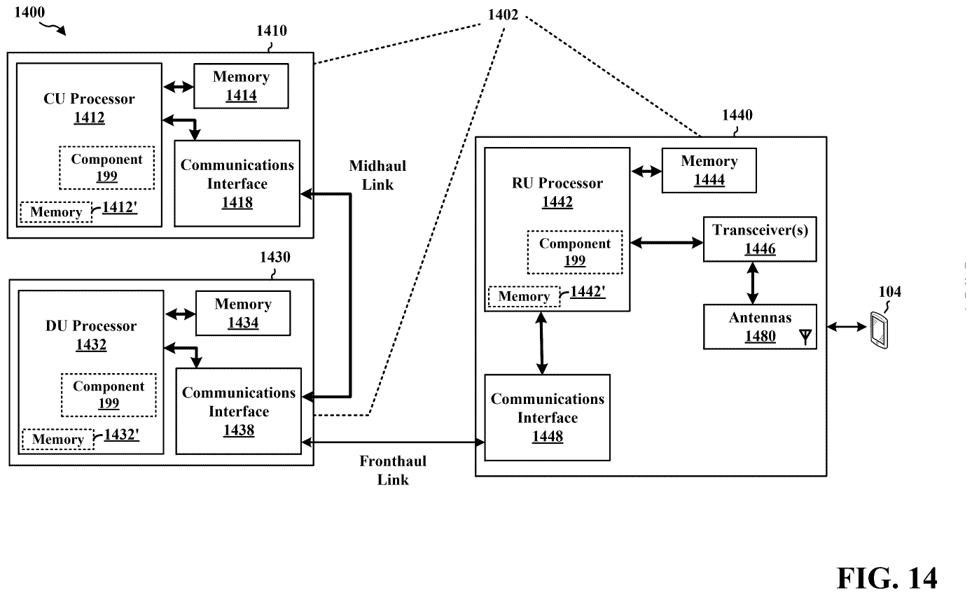

At 1202, the first base station may transmit the plurality of DL signals, where the plurality of DL signals includes DL-PRS, SIBs, CSI-RS, DM-RS, or a combination thereof, such as described in connection with FIGS. 7 and 8. For example, at 810 of FIG. 8, the first base station 804 may transmit DL PRSs to the UE 802. The transmission of the plurality of DL signals may be performed by, e.g., the positioning configuration update process component 199 and/or the transceiver(s) 1446 of the network entity 1402 in FIG. 14.

At 1204, the first base station may receive a request for an updated configuration for a set of SRS positioning resources from a UE, where the request for the updated configuration for the set of SRS positioning resources is based on a set of measurements associated with a plurality of DL signals, such as described in connection with FIGS. 7 and 8. For example, at 818 of FIG. 8, the base station 804 may receive a request 820 for UL SRS configuration update from the UE 802 based on the PRS measurements performed by the UE 802. The reception of the request may be performed by, e.g., the positioning configuration update process component 199 and/or the transceiver(s) 1446 of the network entity 1402 in FIG. 14.

In one example, the request for the updated configuration for the set of SRS positioning resources is received via an UL SDT message during an RRC inactive state of the UE. In such an example, the UL SDT message further includes a set of L1-RSRP measurements, a set of intra-frequency positioning measurements, or a set of inter-frequency positioning measurements, or a combination thereof.

At 1206, the first base station may receive at least one of an RRC resume request or a report of the set of measurements associated with the plurality of DL signals from the UE, such as described in connection with FIGS. 7 and 8. For example, at 818 of FIG. 8, the first base station 804 may receive an RRC resume request 822 and/or a measurement report 824 associated with the DL PRS from the UE 802. The reception of the RRC resume request or the report may be performed by, e.g., the positioning configuration update process component 199 and/or the transceiver(s) 1446 of the network entity 1402 in FIG. 14.

In one example, the report of the set of measurements associated with the plurality of DL signals is received via RRC signaling or a MAC-CE.

At 1208, the first base station may configure the updated configuration for the set of SRS positioning resources based on at least one of: the request for the updated configuration for the set of SRS positioning resources, an RRC resume request, or a report of the set of measurements associated with the plurality of DL signals, such as described in connection with FIG. 7. For example, at 730 of FIG. 7, the base station 704 may determine updated UL SRS resources available for the UE 702 based on the request 720 for SRS configuration update. The configuration of the updated configuration for the set of SRS positioning resources may be performed by, e.g., the positioning configuration update process component 199 and/or the transceiver(s) 1446 of the network entity 1402 in FIG. 14.

At 1210, the first base station may transmit an indication of at least one of: the updated configuration for the set of SRS positioning resources or a configuration for a CFRA procedure at a second network entity, such as described in connection with FIG. 7. For example, at 740 of FIG. 7, based on the new UL SRS configuration 736 received from the LMF 706, the base station 704 may send the new UL SRS configuration 736 to the UE 702, such as via a DL SDT message. In addition, the DL SDT message may also carry a DL report acknowledgement and an RRC release message. The transmission of the indication may be performed by, e.g., the positioning configuration update process component 199 and/or the transceiver(s) 1446 of the network entity 1402 in FIG. 14.

In one example, the indication of the updated configuration for the set of SRS positioning resources is transmitted to the UE via a DL SDT message. In such an example, the DL SDT message further includes an RRC release message.

At 1212, the first base station may perform a handover procedure to transfer the UE to the second network entity, such as described in connection with FIG. 8. For example, at 830 of FIG. 8, the first base station 804 may determine to transfer the UE 802 to the second base station 808. The handover procedure may be performed by, e.g., the positioning configuration update process component 199 and/or the transceiver(s) 1446 of the network entity 1402 in FIG. 14.

In one example, the handover procedure is performed based on the second network entity having a more suitable positioning measurement compared to the first network entity. In another example, the first base station may receive the configuration for the CFRA procedure from the second network entity prior to transmitting the indication.

At 1214, the first base station may transmit an SRS suspend configuration, the configuration for the CFRA procedure at the second network entity, and a positioning session suspend configuration to the UE, such as described in connection with FIG. 8. For example, at 838 of FIG. 8, the first base station 804 transmit the CFRA configuration to the UE 802 via a DL SDT message. In addition, the DL SDT message may further include an SRS suspend configuration, an acknowledgement for the request 820, and/or a positioning session suspend notification, etc. The transmission of the SRS suspend configuration, the configuration for the CFRA procedure at the second network entity, and the positioning session suspend configuration may be performed by, e.g., the positioning configuration update process component 199 and/or the transceiver(s) 1446 of the network entity 1402 in FIG. 14.

In one example, the SRS suspend configuration, the configuration for the CFRA procedure at the second network entity, and the positioning session suspend configuration are transmitted via a DL SDT message.

In another example, the updated configuration for the set of SRS positioning resources is transmitted from the second network entity based on the CFRA procedure.

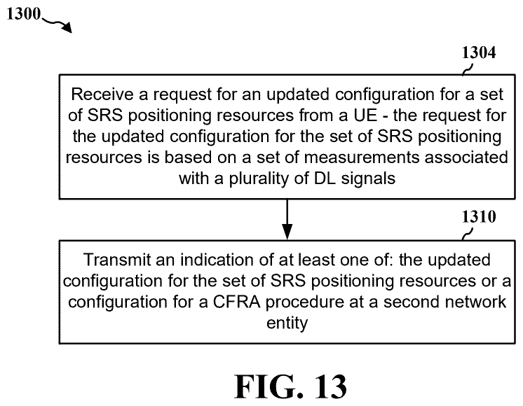

FIG. 13 is a flowchart 1300 of a method of wireless communication. The method may be performed by a first base station (e.g., the base station 102, 704, 804, 808; the network entity 1402. The method may enable the first base station to receive a request for a positioning update from a UE during an RRC inactive state of the UE, and to provide a positioning update to the UE or to handover the UE to a second base station based on the request.

At 1304, the first base station may receive a request for an updated configuration for a set of SRS positioning resources from a UE, where the request for the updated configuration for the set of SRS positioning resources is based on a set of measurements associated with a plurality of DL signals, such as described in connection with FIGS. 7 and 8. For example, at 818 of FIG. 8, the base station 804 may receive a request 820 for UL SRS configuration update from the UE 802 based on the PRS measurements performed by the UE 802. The reception of the request may be performed by, e.g., the positioning configuration update process component 199 and/or the transceiver(s) 1446 of the network entity 1402 in FIG. 14.

In one example, the first base station may transmit the plurality of DL signals, where the plurality of DL signals includes DL-PRS, SIBs, CSI-RS, DM-RS, or a combination thereof, such as described in connection with FIGS. 7 and 8. For example, at 810 of FIG. 8, the first base station 804 may transmit DL PRSs to the UE 802. The transmission of the plurality of DL signals may be performed by, e.g., the positioning configuration update process component 199 and/or the transceiver(s) 1446 of the network entity 1402 in FIG. 14.

In another example, the request for the updated configuration for the set of SRS positioning resources is received via an UL SDT message during an RRC inactive state of the UE. In such an example, the UL SDT message further includes a set of L1-RSRP measurements, a set of intra-frequency positioning measurements, or a set of inter-frequency positioning measurements, or a combination thereof.

In another example, the first base station may receive at least one of an RRC resume request or a report of the set of measurements associated with the plurality of DL signals from the UE, such as described in connection with FIGS. 7 and 8. For example, at 818 of FIG. 8, the first base station 804 may receive an RRC resume request 822 and/or a measurement report 824 associated with the DL PRS from the UE 802. The reception of the RRC resume request or the report may be performed by, e.g., the positioning configuration update process component 199 and/or the transceiver(s) 1446 of the network entity 1402 in FIG. 14.

In another example, the report of the set of measurements associated with the plurality of DL signals is received via RRC signaling or a MAC-CE.

In another example, the first base station may configure the updated configuration for the set of SRS positioning resources based on at least one of: the request for the updated configuration for the set of SRS positioning resources, an RRC resume request, or a report of the set of measurements associated with the plurality of DL signals, such as described in connection with FIG. 7. For example, at 730 of FIG. 7, the base station 704 may determine updated UL SRS resources available for the UE 702 based on the request 720 for SRS configuration update. The configuration of the updated configuration for the set of SRS positioning resources may be performed by, e.g., the positioning configuration update process component 199 and/or the transceiver(s) 1446 of the network entity 1402 in FIG. 14.

At 1310, the first base station may transmit an indication of at least one of: the updated configuration for the set of SRS positioning resources or a configuration for a CFRA procedure at a second network entity, such as described in connection with FIG. 7. For example, at 740 of FIG. 7, based on the new UL SRS configuration 736 received from the LMF 706, the base station 704 may send the new UL SRS configuration 736 to the UE 702, such as via a DL SDT message. In addition, the DL SDT message may also carry a DL report acknowledgement and an RRC release message. The transmission of the indication may be performed by, e.g., the positioning configuration update process component 199 and/or the transceiver(s) 1446 of the network entity 1402 in FIG. 14.

In one example, the indication of the updated configuration for the set of SRS positioning resources is transmitted to the UE via a DL SDT message. In such an example, the DL SDT message further includes an RRC release message.

In another example, the first base station may perform a handover procedure to transfer the UE to the second network entity, such as described in connection with FIG. 8. For example, at 830 of FIG. 8, the first base station 804 may determine to transfer the UE 802 to the second base station 808. The handover procedure may be performed by, e.g., the positioning configuration update process component 199 and/or the transceiver(s) 1446 of the network entity 1402 in FIG. 14. In such an example, the handover procedure is performed based on the second network entity having a more suitable positioning measurement compared to the first network entity.

In another example, the first base station may receive the configuration for the CFRA procedure from the second network entity prior to transmitting the indication. In such an example, the first base station may transmit an SRS suspend configuration, the configuration for the CFRA procedure at the second network entity, and a positioning session suspend configuration to the UE, such as described in connection with FIG. 8. For example, at 838 of FIG. 8, the first base station 804 transmit the CFRA configuration to the UE 802 via a DL SDT message. In addition, the DL SDT message may further include an SRS suspend configuration, an acknowledgement for the request 820, and/or a positioning session suspend notification, etc. The transmission of the SRS suspend configuration, the configuration for the CFRA procedure at the second network entity, and the positioning session suspend configuration may be performed by, e.g., the positioning configuration update process component 199 and/or the transceiver(s) 1446 of the network entity 1402 in FIG. 14. In such an example, the SRS suspend configuration, the configuration for the CFRA procedure at the second network entity, and the positioning session suspend configuration are transmitted via a DL SDT message. In such an example, the updated configuration for the set of SRS positioning resources is transmitted from the second network entity based on the CFRA procedure.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive a request for an updated configuration for a set of SRS positioning resources from a UE, where the request for the updated configuration for the set of SRS positioning resources is based on a set of measurements associated with a plurality of DL signals; and transmit an indication of at least one of: the updated configuration for the set of SRS positioning resources or a configuration for a CFRA procedure at a second network entity. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for receiving a request for an updated configuration for a set of SRS positioning resources from a UE, where the request for the updated configuration for the set of SRS positioning resources is based on a set of measurements associated with a plurality of DL signals. The apparatus 1104 may also include means for transmitting an indication of at least one of: the updated configuration for the set of SRS positioning resources or a configuration for a CFRA procedure at a second network entity.

In one configuration, the apparatus 1104 may also include means for transmitting the plurality of DL signals, where the plurality of DL signals includes DL-PRS, SIBs, CSI-RS, DM-RS, or a combination thereof.

In another configuration, the request for the updated configuration for the set of SRS positioning resources is received via an UL SDT message during an RRC inactive state of the UE. In such a configuration, the UL SDT message further includes a set of L1-RSRP measurements, a set of intra-frequency positioning measurements, or a set of inter-frequency positioning measurements, or a combination thereof.

In another configuration, the apparatus 1104 may also include means for receiving at least one of an RRC resume request or a report of the set of measurements associated with the plurality of DL signals from the UE.

In another configuration, the report of the set of measurements associated with the plurality of DL signals is received via RRC signaling or a MAC-CE.

In another configuration, the apparatus 1104 may also include means for configuring the updated configuration for the set of SRS positioning resources based on at least one of: the request for the updated configuration for the set of SRS positioning resources, an RRC resume request, or a report of the set of measurements associated with the plurality of DL signals.

In another configuration, the indication of the updated configuration for the set of SRS positioning resources is transmitted to the UE via a DL SDT message. In such a configuration, the DL SDT message further includes an RRC release message.

In another configuration, the apparatus 1104 may also include means for performing a handover procedure to transfer the UE to the second network entity. In such a configuration, the handover procedure is performed based on the second network entity having a more suitable positioning measurement compared to the first network entity.

In another configuration, the apparatus 1104 may also include means for receiving the configuration for the CFRA procedure from the second network entity prior to transmitting the indication. In such a configuration, the apparatus 1104 may also include means for transmitting an SRS suspend configuration, the configuration for the CFRA procedure at the second network entity, and a positioning session suspend configuration to the UE. In such a configuration, the SRS suspend configuration, the configuration for the CFRA procedure at the second network entity, and the positioning session suspend configuration are transmitted via a DL SDT message. In such a configuration, the updated configuration for the set of SRS positioning resources is transmitted from the second network entity based on the CFRA procedure.

The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: performing a set of measurements associated with a plurality of DL signals from a first network entity, where the set of measurements is performed during an RRC inactive state of the UE; transmitting, based on the set of measurements for the plurality of DL signals, a request for an updated configuration for a set of SRS positioning resources to the first network entity; and receiving an indication of the updated configuration for the set of SRS positioning resources based on the request.

Aspect 2 is the method of aspect 1, further including: transmitting, based on the set of measurements for the plurality of DL signals, at least one of an RRC resume request or a report of the set of measurements associated with the plurality of DL signals to the first network entity.

Aspect 3 is the method of aspect 2, where the report of the set of measurements associated with the plurality of DL signals is transmitted to the first network entity via RRC signaling or a MAC-CE.

Aspect 4 is the method of any of aspects 1 to 3, where the request for the updated configuration for the set of SRS positioning resources is transmitted via an UL SDT message.

Aspect 5 is the method of aspect 4, where the UL SDT message further includes a set of L1-RSRP measurements, a set of intra-frequency positioning measurements, or a set of inter-frequency positioning measurements, or a combination thereof.

Aspect 6 is the method of any of aspects 1 to 5, where the plurality of DL signals includes DL-PRS, SIBs, CSI-RS, DM-RS, or a combination thereof.

Aspect 7 is the method of any of aspects 1 to 6, where the indication of the updated configuration for the set of SRS positioning resources is received from the first network entity.

Aspect 8 is the method of any of aspects 1 to 7, further including: receiving, from the first network entity, a configuration for a CFRA procedure at a second network entity, where the indication of the updated configuration for the set of SRS positioning resources is received from the second network entity based on the CFRA procedure.

Aspect 9 is the method of aspect 8, further including: performing the CFRA procedure with the second network entity based on the configuration for the CFRA procedure at the second network entity; and transmitting a positioning session resume request to the second network entity based on the CFRA procedure.

Aspect 10 is the method of aspect 9, where the indication of the updated configuration for the set of SRS positioning resources is received from the second network entity based on the positioning session resume request.

Aspect 11 is the method of aspect 10, further including: receiving a DL SDT configuration and an UL SDT configuration from the second network entity based on the positioning session resume request, where the indication of the updated configuration for the set of SRS positioning resources, the DL SDT configuration, and the UL SDT configuration are received from the second network entity at a same time.

Aspect 12 is the method of aspect 11, where the indication of the updated configuration for the set of SRS positioning resources, the DL SDT configuration, and the UL SDT configuration are received from the second network entity in an RRC release message.

Aspect 13 is the method of any of aspects 1 to 12, further including: transmitting a set of SRSs using the set of SRS positioning resources based on the updated configuration for the set of SRS positioning resources.

Aspect 14 is an apparatus for wireless communication at a UE, including: a memory; and at least one processor coupled to the memory and, based at least in part on information stored in the memory, the at least one processor is configured to implement any of aspects 1 to 13.

Aspect 15 is the apparatus of aspect 14, further including at least one of an antenna or a transceiver coupled to the at least one processor.

Aspect 16 is an apparatus for wireless communication including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

Aspect 18 is a method of wireless communication at a first network entity, including: receiving a request for an updated configuration for a set of SRS positioning resources from a UE, where the request for the updated configuration for the set of SRS positioning resources is based on a set of measurements associated with a plurality of DL signals; and transmitting an indication of at least one of: the updated configuration for the set of SRS positioning resources or a configuration for a CFRA procedure at a second network entity.

Aspect 19 is the method of aspect 18, further including: receiving at least one of an RRC resume request or a report of the set of measurements associated with the plurality of DL signals from the UE.

Aspect 20 is the method of 19, where the report of the set of measurements associated with the plurality of DL signals is received via RRC signaling or a MAC-CE.

Aspect 21 is the method of any of aspects 18 to 20, where the request for the updated configuration for the set of SRS positioning resources is received via an UL SDT message during an RRC inactive state of the UE.

Aspect 22 is the method of aspect 21, where the UL SDT message further includes a set of L1-RSRP measurements, a set of intra-frequency positioning measurements, or a set of inter-frequency positioning measurements, or a combination thereof.

Aspect 23 is the method of any of aspects 18 to 22, further including: transmitting the plurality of DL signals, where the plurality of DL signals includes DL-PRS, SIBs, CSI-RS, DM-RS, or a combination thereof.

Aspect 24 is the method of any of aspects 18 to 23, further including: configuring the updated configuration for the set of SRS positioning resources based on at least one of: the request for the updated configuration for the set of SRS positioning resources, an RRC resume request, or a report of the set of measurements associated with the plurality of DL signals.

Aspect 25 is the method of any of aspects 18 to 24, where the indication of the updated configuration for the set of SRS positioning resources is transmitted to the UE via a DL SDT message.

Aspect 26 is the method of aspect 25, where the DL SDT message further includes an RRC release message.

Aspect 27 is the method of any of aspects 18 to 26, further including: performing a handover procedure to transfer the UE to the second network entity.

Aspect 28 is the method of any of aspect 27, where the handover procedure is performed based on the second network entity having a more suitable positioning measurement compared to the first network entity.

Aspect 29 is the method of any of aspect 27, further including: receiving the configuration for the CFRA procedure from the second network entity prior to transmitting the indication.

Aspect 30 is the method of any of aspect 29, further including: transmitting an SRS suspend configuration, the configuration for the CFRA procedure at the second network entity, and a positioning session suspend configuration to the UE.

Aspect 31 is the method of any of aspect 30, where the SRS suspend configuration, the configuration for the CFRA procedure at the second network entity, and the positioning session suspend configuration are transmitted via a DL SDT message.

Aspect 32 is the method of any of aspect 29, where the updated configuration for the set of SRS positioning resources is transmitted from the second network entity based on the CFRA procedure.

Aspect 33 is an apparatus for wireless communication at a first base station, including: a memory; and at least one processor coupled to the memory and, based at least in part on information stored in the memory, the at least one processor is configured to implement any of aspects 18 to 32.

Aspect 34 is the apparatus of aspect 33, further including at least one of an antenna or a transceiver coupled to the at least one processor.

Aspect 35 is an apparatus for wireless communication including means for implementing any of aspects 18 to 32.

Aspect 36 is a computer-readable medium (e.g., a non-transitory computer-readable medium) storing computer executable code, where the code when executed by a processor causes the processor to implement any of aspects 18 to 32.

What is claimed is:

1. An apparatus for wireless communication at a user equipment (UE), comprising:
a memory; and
at least one processor coupled to the memory and, based at least in part on information stored in the memory, the at least one processor is configured to:
perform a set of measurements associated with a plurality of downlink (DL) signals from a first network entity, wherein the set of measurements is performed during a radio resource control (RRC) inactive state of the UE;
transmit, based on the set of measurements for the plurality of DL signals, a request for an updated configuration for a set of sounding reference signal (SRS) positioning resources to the first network entity; and
receive an indication of the updated configuration for the set of SRS positioning resources based on the request.

2. The apparatus of claim 1, wherein the at least one processor is further configured to:
transmit, based on the set of measurements for the plurality of DL signals, at least one of an RRC resume request or a report of the set of measurements associated with the plurality of DL signals to the first network entity.

3. The apparatus of claim 2, wherein the report of the set of measurements associated with the plurality of DL signals is transmitted to the first network entity via RRC signaling or a medium access control (MAC)-control element (CE) (MAC-CE).

4. The apparatus of claim 1, wherein the request for the updated configuration for the set of SRS positioning resources is transmitted via an uplink (UL) small data transfer (SDT) message.

5. The apparatus of claim 4, wherein the UL SDT message further includes a set of layer 1 (L1) reference signal received power (RSRP) (L1-RSRP) measurements, a set of intra-frequency positioning measurements, or a set of inter-frequency positioning measurements, or a combination thereof.

6. The apparatus of claim 1, wherein the plurality of DL signals includes DL-positioning reference signals (PRS) (DL-PRS), system information blocks (SIBs), channel state information reference signals (CSI-RS), demodulation reference signals (DM-RS), or a combination thereof.

7. The apparatus of claim 1, wherein the indication of the updated configuration for the set of SRS positioning resources is received from the first network entity.

8. The apparatus of claim 1, wherein the at least one processor is further configured to:
receive, from the first network entity, a configuration for a contention-free random access (CFRA) procedure at a second network entity, wherein the indication of the updated configuration for the set of SRS positioning resources is received from the second network entity based on the CFRA procedure.

9. The apparatus of claim 8, wherein the at least one processor is further configured to:
perform the CFRA procedure with the second network entity based on the configuration for the CFRA procedure at the second network entity; and
transmit a positioning session resume request to the second network entity based on the CFRA procedure.

10. The apparatus of claim 9, wherein the indication of the updated configuration for the set of SRS positioning resources is received from the second network entity based on the positioning session resume request.

11. The apparatus of claim 10, wherein the at least one processor is further configured to:
receive a DL small data transfer (SDT) configuration and an uplink (UL) SDT configuration from the second network entity based on the positioning session resume request, wherein the indication of the updated configuration for the set of SRS positioning resources, the DL SDT configuration, and the UL SDT configuration are received from the second network entity at a same time.

12. The apparatus of claim 11, wherein the indication of the updated configuration for the set of SRS positioning resources, the DL SDT configuration, and the UL SDT configuration are received from the second network entity in an RRC release message.

13. The apparatus of claim 1, wherein the at least one processor is further configured to:
transmit a set of SRSs using the set of SRS positioning resources based on the updated configuration for the set of SRS positioning resources.

14. A method of wireless communication at a user equipment (UE), comprising:
performing a set of measurements associated with a plurality of downlink (DL) signals from a first network entity, wherein the set of measurements is performed during a radio resource control (RRC) inactive state of the UE;
transmitting, based on the set of measurements for the plurality of DL signals, a request for an updated configuration for a set of sounding reference signal (SRS) positioning resources to the first network entity; and
receiving an indication of the updated configuration for the set of SRS positioning resources based on the request.

15. An apparatus for wireless communication at a first network entity, comprising:
a memory; and
at least one processor coupled to the memory and, based at least in part on information stored in the memory, the at least one processor is configured to:
receive a request for an updated configuration for a set of sounding reference signal (SRS) positioning resources from a user equipment (UE), wherein the request for the updated configuration for the set of SRS positioning resources is based on a set of measurements associated with a plurality of downlink (DL) signals; and
transmit an indication of at least one of: the updated configuration for the set of SRS positioning resources or a configuration for a contention-free random access (CFRA) procedure at a second network entity.

16. The apparatus of claim 15, wherein the at least one processor is further configured to:
receive at least one of a radio resource control (RRC) resume request or a report of the set of measurements associated with the plurality of DL signals from the UE.

17. The apparatus of claim 16, wherein the report of the set of measurements associated with the plurality of DL signals is received via RRC signaling or a medium access control (MAC)-control element (CE) (MAC-CE).

18. The apparatus of claim 15, wherein the request for the updated configuration for the set of SRS positioning resources is received via an uplink (UL) small data transfer (SDT) message during a radio resource control (RRC) inactive state of the UE.

19. The apparatus of claim 18, wherein the UL SDT message further includes a set of layer 1 (L1) reference signal received power (RSRP) (L1-RSRP) measurements, a set of intra-frequency positioning measurements, or a set of inter-frequency positioning measurements, or a combination thereof.

20. The apparatus of claim 15, wherein the at least one processor is further configured to:
transmit the plurality of DL signals, wherein the plurality of DL signals includes DL-positioning reference signals (PRS) (DL-PRS), system information blocks (SIBs), channel state information reference signals (CSI-RS), demodulation reference signals (DM-RS), or a combination thereof.

21. The apparatus of claim 15, wherein the at least one processor is further configured to:
configure the updated configuration for the set of SRS positioning resources based on at least one of: the request for the updated configuration for the set of SRS positioning resources, a radio resource control (RRC) resume request, or a report of the set of measurements associated with the plurality of DL signals.

22. The apparatus of claim 15, wherein the indication of the updated configuration for the set of SRS positioning resources is transmitted to the UE via a DL small data transfer (SDT) message.

23. The apparatus of claim 22, wherein the DL SDT message further includes an RRC release message.

24. The apparatus of claim 15, wherein the at least one processor is further configured to:
perform a handover procedure to transfer the UE to the second network entity.

25. The apparatus of claim 24, wherein the handover procedure is performed based on the second network entity having a more suitable positioning measurement compared to the first network entity.

26. The apparatus of claim 24, wherein the at least one processor is further configured to:
receive the configuration for the CFRA procedure from the second network entity prior to transmitting the indication.

27. The apparatus of claim 26, wherein the at least one processor is further configured to:
transmit an SRS suspend configuration, the configuration for the CFRA procedure at the second network entity, and a positioning session suspend configuration to the UE.

28. The apparatus of claim 27, wherein the SRS suspend configuration, the configuration for the CFRA procedure at the second network entity, and the positioning session suspend configuration are transmitted via a DL small data transfer (SDT) message.

29. The apparatus of claim 26, wherein the updated configuration for the set of SRS positioning resources is transmitted from the second network entity based on the CFRA procedure.

30. A method of wireless communication at a first network entity, comprising:
receiving a request for an updated configuration for a set of sounding reference signal (SRS) positioning resources from a user equipment (UE), wherein the request for the updated configuration for the set of SRS positioning resources is based on a set of measurements associated with a plurality of downlink (DL) signals; and
transmitting an indication of at least one of: the updated configuration for the set of SRS positioning resources or a configuration for a contention-free random access (CFRA) procedure at a second network entity.
